(19) United States
(12) Patent Application Publication
(10) Pub. No.: US 2023/0300743 A1
(43) Pub. Date: Sep. 21, 2023

(54) INDICATION INFORMATION VALIDATION METHOD AND APPARATUS, TERMINAL, AND READABLE STORAGE MEDIUM

(71) Applicant: VIVO MOBILE COMMUNICATION CO., LTD., Dongguan (CN)

(72) Inventors: Dongru LI, Dongguan (CN); Xueming PAN, Dongguan (CN); Kai WU, Dongguan (CN); Na LI, Dongguan (CN)

(73) Assignee: VIVO MOBILE COMMUNICATION CO., LTD., Dongguan (CN)

(21) Appl. No.: 18/136,320

(22) Filed: Apr. 18, 2023

Related U.S. Application Data
(63) Continuation of application No. PCT/CN2021/123822, filed on Oct. 14, 2021.

(30) Foreign Application Priority Data
Oct. 19, 2020 (CN) 202011120101.4

(51) Int. Cl. H04W 52/02; H04W 72/23; H04W 72/1273; H04W 72/1268; H04L 1/1812

(52) U.S. Cl. CPC H04W 52/0216; H04L 1/1812; H04W 72/1268; H04W 72/1273; H04W 72/23

(57) ABSTRACT

An indication information validation method, a terminal, and a non-transitory computer readable storage medium are provided. The method includes: receiving a first Downlink Control Indication (DCI). The first DCI is associated with first indication information. The first indication information is an indication related to energy saving. The method further includes determining, according to first information, whether the first indication information is valid.

### CROSS-REFERENCE TO RELATED APPLICATIONS

This application is a continuation of International Application No. PCT/CN2021/123822, filed on Oct. 14, 2021, which claims priority to Chinese Patent Application No. 202011120101.4, filed on Oct. 19, 2020. The entire contents of each of the above-referenced applications are expressly incorporated herein by reference.

### TECHNICAL FIELD

This application pertains to the field of communications technologies, and specifically relates to an indication information validation method and apparatus, a terminal, and a readable storage medium.

### BACKGROUND

In mobile communication, a terminal may complete Physical Downlink Control Channel (PDCCH) monitoring cycle relaxation, skip PDCCH monitoring, reduce a receive bandwidth, and the like by receiving signaling related to energy saving of the terminal and in another implicit manner, thereby implementing energy-saving and power-saving of the terminal. The signaling related to energy saving of the terminal includes a search space group indication, a Bandwidth Part (BWP) indication, a sleep state switching indication, and the like. However, because the terminal enters the foregoing energy saving mode, a data transmission delay increases, data transmission reliability decreases, and performance of UE is affected.

### SUMMARY

Embodiments of this application provide an indication information validation method and apparatus, a terminal, and a readable storage medium.

According to a first aspect, an indication information validation method is provided and is applied to a terminal, including: receiving a first Downlink Control Indication (DCI), where the first DCI is associated with first indication information, and the first indication information is an indication related to energy saving; and determining, according to first information, whether the first indication information is valid, where the first information includes at least one of the following: a value of a Hybrid Automatic Repeat reQuest HARQ-ACK feedback information bit of the first DCI; a value of a HARQ-ACK feedback information bit of a Physical Downlink Shared Channel (PDSCH) scheduled by the first DCI; a Downlink Feedback Indication (DFI) of a Physical Uplink Shared Channel (PUSCH) scheduled by the first DCI; whether the PDSCH or the PUSCH scheduled by the first DCI is correctly decoded; whether a retransmission timer associated with the PDSCH or the PUSCH scheduled by the first DCI is started or restarted; whether a first timer expires, where the first timer is started or restarted after sending of the PUSCH scheduled by the first DCI is completed; or a validation delay of the first indication information.

According to a second aspect, an indication information validation apparatus is provided, including: a receiving module, configured to receive a first DCI, where the first DCI is associated with first indication information, and the first indication information is an indication related to energy saving; and a determining module, configured to determine, according to first information, whether the first indication information is valid, where the first information includes at least one of the following: a value of a HARQ-ACK feedback information bit of the first DCI; a value of a HARQ-ACK feedback information bit of a PDSCH scheduled by the first DCI; a DFI of a PUSCH scheduled by the first DCI; whether the PDSCH or the PUSCH scheduled by the first DCI is correctly decoded; whether a retransmission timer associated with the PDSCH or the PUSCH scheduled by the first DCI is started or restarted; whether a first timer expires, where the first timer is started or restarted after sending of the PUSCH scheduled by the first DCI is completed; or a validation delay of the first indication information.

According to a third aspect, a terminal is provided. The terminal includes a processor, a memory, and a program or an instruction that is stored in the memory and that can be run on the processor, where when the program or the instruction is executed by the processor, the steps of the method in the first aspect are implemented.

According to a fourth aspect, a readable storage medium is provided. The readable storage medium stores a program or an instruction, and when the program or the instruction is executed by a processor, the steps of the method in the first aspect are implemented.

According to a fifth aspect, a chip is provided. The chip includes a processor and a communications interface, the communications interface is coupled to the processor, and the processor is configured to run a program or an instruction of a terminal to implement the method in the first aspect.

According to a sixth aspect, a computer program product is provided. The computer program product is stored in a non-volatile storage medium, and the program product is executed by at least one processor to implement the method in the first aspect.

In the embodiments of this application, it may be determined, according to a value of a HARQ-ACK feedback information bit of a first DCI, a value of a HARQ-ACK feedback information bit of a PDSCH scheduled by the first DCI, a DFI of a PUSCH scheduled by the first DCI, whether the PDSCH or the PUSCH scheduled by the first DCI is correctly decoded, whether a retransmission timer associated with the PDSCH or the PUSCH scheduled by the first DCI is started or restarted, whether a first timer expires, or a validation delay of first indication information, whether the first indication information is valid.

### BRIEF DESCRIPTION OF DRAWINGS

FIG. 1 is a block diagram of a wireless communications system to which embodiments of this application can be applied;

FIG. 2 is a schematic diagram of a DRX cycle according to an embodiment of this application;

FIG. 3 is a schematic diagram of configuring an inactive timer within a DRX cycle according to an embodiment of this application;

FIG. 4 is a schematic diagram of controlling a HARQ-ACK feedback by using a feedback retransmission related timer configured through DRX according to an embodiment of this application;

FIG. 5 is a flowchart of an indication information validation method according to an embodiment of this application;

FIG. 6 is a first schematic diagram of determining, according to a HARQ-ACK feedback, whether an indication of PDCCH monitoring skipping is valid according to an embodiment of this application;

FIG. 7 is a second schematic diagram of determining, according to a HARQ-ACK feedback, whether an indication of PDCCH monitoring skipping is valid according to an embodiment of this application;

FIG. 8 is a third schematic diagram of determining, according to a HARQ-ACK feedback, whether an indication of PDCCH monitoring skipping is valid according to an embodiment of this application;

FIG. 9 is a fourth schematic diagram of determining, according to a HARQ-ACK feedback, whether an indication of PDCCH monitoring skipping is valid according to an embodiment of this application;

FIG. 10 is a fifth schematic diagram of determining, according to a HARQ-ACK feedback, whether an indication of PDCCH monitoring skipping is valid according to an embodiment of this application;

FIG. 11 is a schematic structural diagram of an indication information validation apparatus according to an embodiment of this application;

FIG. 12 is a schematic structural diagram of a communications device according to an embodiment of this application; and

FIG. 13 is a schematic structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

In the specification and claims of this application, the terms “first”, “second”, and the like are intended to distinguish between similar objects but do not describe a specific order or sequence. It should be understood that, data termed in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe a New Radio (NR) system for example purposes, and NR terms are used in most of the following descriptions, but these technologies can also be applied to an application other than an NR system application, for example, a 6^{th} Generation (6G) communications system.

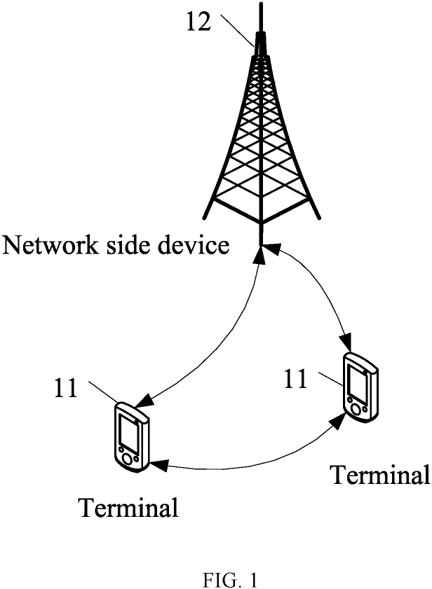

FIG. 1 is a block diagram of a wireless communications system to which embodiments of this application can be applied. The wireless communications system includes a terminal 11 and a network side device 12. The terminal 11 may also be referred to as a terminal device or a User Equipment (UE). The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), a wearable device, Vehicle User Equipment (VUE), or Pedestrian User Equipment (PUE). The wearable device includes a bracelet, a headset, glasses, and the like. It should be noted that a specific type of the terminal 11 is not limited in the embodiments of this application. The network side device 12 may be a base station or a core network. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a WLAN access point, a Wi-Fi node, a Transmission Reception Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

Related terms in the embodiments of this application are first described.

### 1. Discontinuous Reception (DRX) in a Radio Resource Control (RRC) Connected State

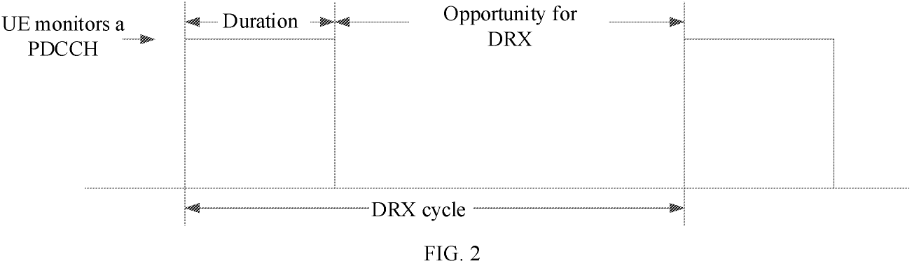

A basic DRX cycle is shown in FIG. 2, where the DRX cycle includes on duration and an opportunity for DRX. Within the on duration, UE monitors a PDCCH (no PDCCH is monitored in FIG. 2). During the opportunity for DRX, the UE does not monitor the PDCCH to reduce power consumption.

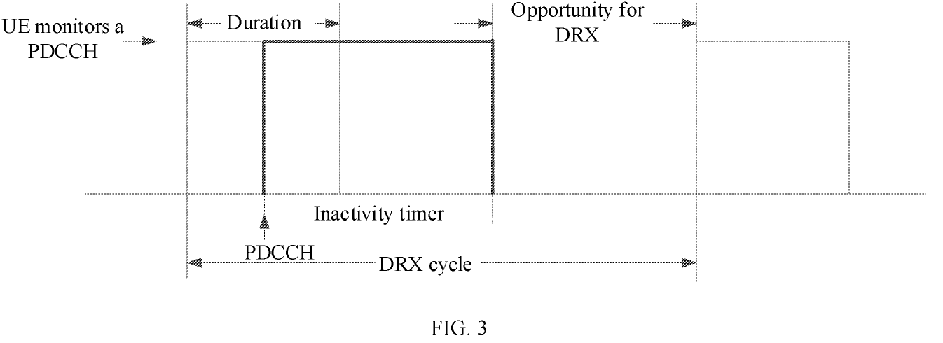

In addition, as shown in FIG. 3, a network configures an inactivity timer. If a newly transmitted PDCCH is received within the on duration, the inactivity timer is started or restarted to prolong duration in which the UE monitors the PDCCH.

### 2. Discontinuous Reception Timer (DRX Timer)

With reference to a DRX basic model, descriptions of DRX retransmission related timers shown in Table 1 are provided.

TABLE 1

| | |
|---|---|
| Retransmission timer | Function |
| Downlink DRX retransmission timer drx-RetransmissionTimerDL | The timer is a per HARQ process (per HARQ process) parameter, indicating maximum duration in which a PDCCH needs to be monitored to receive a next downlink retransmission. During running of the timer, corresponding MAC monitors the PDCCH. The timer is started at a first symbol after downlink DRX HARQ Round-Trip Time Timer (drx-HARQ-RTT-Timer) expires. The timer is stopped when a PDCCH indicating downlink transmission is received. The |
| | retransmission timer indicates a maximum quantity of PDCCH slots that the UE needs to continuously monitor to receive expected downlink retransmission data. |
| Downlink drx-HARQ-RTT-TimerDL | The timer is a per HARQ process parameter, indicating minimum duration required for receiving a downlink assignment used for retransmission. The timer is started at a first symbol after sending of a downlink HARQ feedback ends. During running of the timer, the corresponding MAC does not monitor the PDCCH. When the timer expires, drx-RetransmissionTimerDL corresponding to a HARQ process is started. |
| drx-RetransmissionTimerUL | The timer is a per HARQ process parameter, indicating maximum duration required for receiving an uplink grant used for uplink retransmission. During running of the timer, corresponding MAC monitors the PDCCH. The timer is started at a first symbol after drx-HARQ-RTT-TimerUL expires. The timer is stopped when a PDCCH indicating uplink transmission is received. |
| Uplink DRX retransmission timer drx-HARQ-RTT-TimerUL | The timer is a per HARQ process parameter, indicating minimum duration required for receiving an uplink grant used for retransmission. During running of the timer, the corresponding MAC does not monitor the PDCCH. The timer is started at a first symbol after the first repetition of PUSCH transmission corresponding to the HARQ ends. When the timer expires, drx-RetransmissionTimerUL corresponding to a HARQ process is started. |

### 3. Energy-Saving Technology

PDCCH skipping is a method for reducing PDCCH monitoring. For example, a PDCCH skipping DCI is used to instruct to skip PDCCH monitoring in the following slots 4, 8, and 16. A time skipped in this period is referred to as skipping duration in the following solution. UE does not need to monitor a PDCCH in this period. Therefore, energy saving of a terminal can be implemented.

Two search space groups are introduced in search space group switching. A feature of a search space in a search space group 0 is a sparser PDCCH monitoring cycle, and a search space group 1 has a denser PDCCH monitoring cycle, and therefore the UE may be switched between the two groups by using an explicit or implicit mechanism.

In BWP switching, for example, bandwidths of two BWPs are respectively 100 M and 20 M. ADCI for BWP switching can implement switching from a 100 M large bandwidth BWP to a 20 M energy-saving bandwidth can be implemented, thereby implementing energy saving of terminal.

### 4. HARQ Feedback

Case 1: A Physical Uplink Shared Channel (PUSCH) feedback and a Physical Downlink Shared Channel (PDSCH) feedback are when DRX is not configured.

For the PDSCH, the UE side has a clear HARQ feedback process according to whether the PDSCH is correctly received. However, in NR, there is no explicit HARQ feedback for the PUSCH.

### Case 2: HARQ Feedback in a DRX Configuration

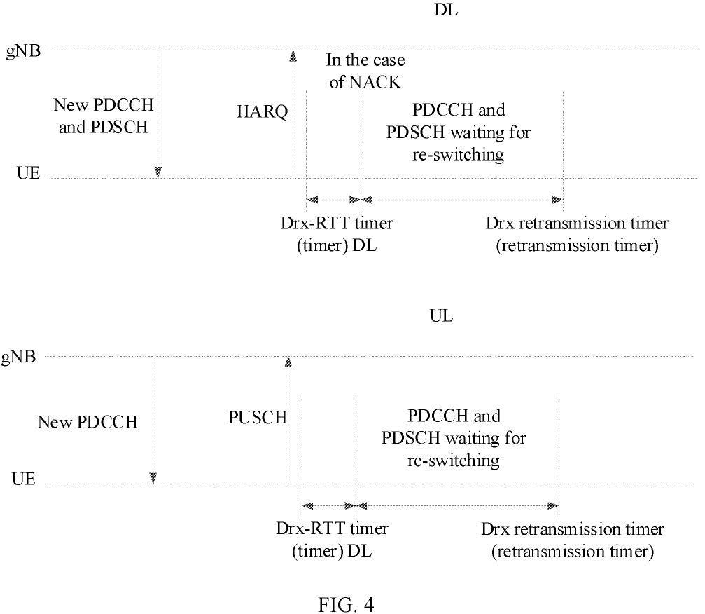

The HARQ feedback may be controlled by using a feedback retransmission related timer configured in DRX, as shown in FIG. 4, a DRX retransmission timer (drx-RetransmissionTimer) and a DRX Hybrid Automatic Repeat Request Round-Trip Time Timer (drx-HARQ-RTT-Timer). In a downlink process, the retransmission timer is started only when a feedback is NACK, and both the RTT timer and the retransmission timer need to be started in an uplink.

With reference to the accompanying drawings, the indication information validation method provided in the embodiments of this application is described in detail by using specific embodiments and application scenarios.

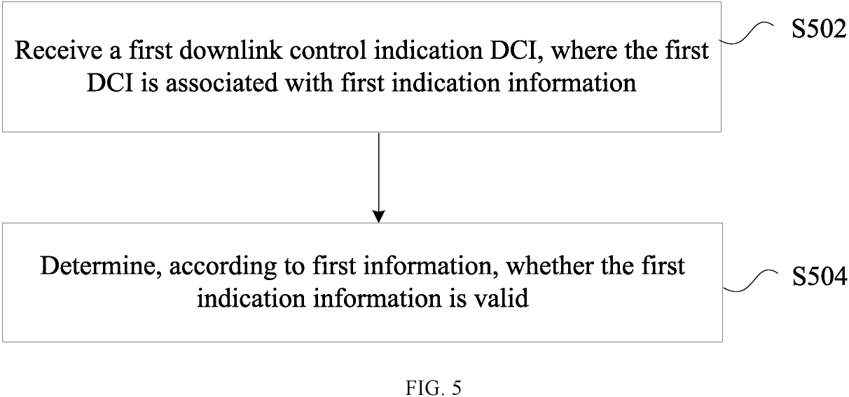

This application provides an indication information validation method, and the method is applied to a terminal. FIG. 5 is a flowchart of an indication information validation method according to an embodiment of this application. As shown in FIG. 5, steps of the method include:

Step S502: Receive a first DCI, where the first DCI is associated with first indication information, and the first indication information is an indication related to energy saving.

Step S504: Determine, according to first information, whether the first indication information is valid.

The first information includes at least one of the following:
a value of a HARQ-ACK feedback information bit of the first DCI;
a value of a HARQ-ACK feedback information bit of a PDSCH scheduled by the first DCI;
a DFI of a PUSCH scheduled by the first DCI;
whether the PDSCH or the PUSCH scheduled by the first DCI is correctly decoded;
whether a retransmission timer associated with the PDSCH or the PUSCH scheduled by the first DCI is started or restarted;
whether a first timer expires, where the first timer is started or restarted after sending of the PUSCH scheduled by the first DCI is completed; or
a validation delay of the first indication information.

According to step S502 and step S504 in this embodiment of this application, it may be determined, according to a value of a HARQ-ACK feedback information bit of a first DCI, a value of a HARQ-ACK feedback information bit of a PDSCH scheduled by the first DCI, a DFI of a PUSCH scheduled by the first DCI, whether the PDSCH or the PUSCH scheduled by the first DCI is correctly decoded, whether a retransmission timer associated with the PDSCH or the PUSCH scheduled by the first DCI is started or restarted, whether a first timer expires, or a validation delay of first indication information, whether the first indication information is valid.

It should be noted that the retransmission timer in this embodiment of this application may be a downlink DRX retransmission timer (drx-retransmissiontimerDL), a configured grant retransmission timer (cg-RetransmissionTimer), or another retransmission timer in a specific application scenario, but is not limited thereto.

In addition, the first timer in this embodiment of this application may be an uplink DRX retransmission timer (drx-retransmissiontimerUL).

In an implementation in this embodiment of this application, the manner of determining, according to first information, whether the first indication information is valid in step S504 may further include:

Step S504-11: In a case that the first DCI is a DCI for non-scheduled data, and the value of the HARQ-ACK feedback information bit of the first DCI is an ACK, determine that the first indication information is valid.

In an implementation of this embodiment of this application, the manner of determining that the first indication information is valid in step S504-11: may include at least one of the following:

Step S11: Determine that the first indication information is valid after a HARQ-ACK feedback of the first DCI is completed.

Step S12: Determine that the first indication information is valid after a first validation delay of the first indication information.

Step S13: Determine that the first indication information is valid at an (n+K)^{th} time unit.

Reception of a PDCCH of the first DCI is completed at an n^{th} time unit, where K is an integer greater than or equal to 0.

In this embodiment of this application, the time unit may be one of the following: a slot, a symbol, a subframe, and a millisecond (ms).

In this embodiment of this application, a value of K in step S13 may be determined by using at least one of the following:
(1) K1, where a value of K1 is a time interval between a completion position of a time unit in which the PDCCH for the first DCI is received and a start position of a time unit in which a Physical Uplink Control Channel (PUCCH) for feeding back the HARQ-ACK feedback of the first DCI is located; or
(2) a Subcarrier Spacing (SCS) configuration of the PUCCH carrying the HARQ-ACK of the first DCI.

In addition, the first validation delay step S12 may be: a time interval between completing reception of the PDCCH on which the first DCI is located and a validation moment of the first indication information; or a time interval between the HARQ-ACK feedback of the first DCI and a validation moment of the first indication information.

According to step S504-11, it may be determined, according to whether the HARQ-ACK feedback bit of the first DCI is an ACK, whether the first indication information is valid and a specific validation moment is determined. Therefore, before an energy saving mode is entered (that is, before the first indication information is valid) and on the premise of ensuring correct reception of the first DCI for non-scheduled data and performance of UE, power saving and energy saving can be achieved.

In an implementation in this embodiment of this application, the manner of determining, according to first information, whether the first indication information is valid in step S504 may further include:

Step S504-12: In a case that the first DCI is a DCI for scheduled data, and the value of the HARQ-ACK feedback information bit of the PDSCH scheduled by the first DCI is an ACK, determine that the first indication information is valid.

The manner of determining that the first indication information is valid in step S504-12 may further include at least one of the following:

Step S21: Determine that the first indication information is valid after a HARQ-ACK feedback of the PDSCH scheduled by the first DCI is completed.

Step S22: Determine that the first indication information is valid after a second validation delay of the first indication information.

Step S23: Determine that the first indication information is valid at an (n+K)^{th} time unit.

Reception of the PDSCH scheduled by the first DCI is completed at an n^{th} time unit, where K is an integer greater than or equal to 0.

A value of K in step S23 may be determined by using at least one of the following:
(1) K2, where a value of K2 is a time interval between a completion position of a time unit in which the PDSCH for the first DCI is received and a start position of a time unit in which a PUCCH for feeding back the HARQ-ACK feedback of the PDSCH is located; or
(2) an SCS configuration of the PUCCH carrying the HARQ-ACK feedback of the PDSCH.

In addition, the second validation delay in step S22 may be: a time interval between completing reception of the PDSCH scheduled by the first DCI and a validation moment of the first indication information; or a time interval between the HARQ-ACK feedback of the PDSCH scheduled by the first DCI and a validation moment of the first indication information.

According to step S504-12, it may be determined, according to whether the HARQ-ACK feedback bit of the PDSCH scheduled by the first DCI is an ACK, whether the first indication information is valid and a specific validation moment is determined. Therefore, before an energy saving mode is entered (for example, before the first indication information is valid) and on the premise of ensuring data transmission reliability and performance of UE, power saving and energy saving can be achieved.

In an implementation in this embodiment of this application, the manner of determining, according to first information, whether the first indication information is valid in step S504 may further include:

Step S504-13: In a case that the first DCI is a DCI for scheduled data, and the PDSCH scheduled by the first DCI is correctly decoded, determine that the first indication information is valid.

The manner of determining that the first indication information is valid in step S504-13 may further include at least one of the following:

Step S31: Determine that the first indication information is valid after the PDSCH scheduled by the first DCI is correctly decoded.

Step S32: Determine that the first indication information is valid after a third validation delay of the first indication information.

It should be noted that, the third validation delay in step S32 may be: a time interval between implementing correct decoding of the PDSCH scheduled by the first DCI and a validation moment of the first indication information; or a time interval between the HARQ-ACK feedback of the PDSCH scheduled by the first DCI and a validation moment of the first indication information.

According to step S504-13, it may be determined, according to a decoding status of the PDSCH scheduled by the first DCI, whether the first indication information is valid and a specific validation moment is determined. Therefore, before an energy saving mode is entered (that is, before the first indication information is valid) and on the premise of ensuring data transmission reliability and performance of UE, power saving and energy saving can be achieved.

In an implementation in this embodiment of this application, the manner of determining, according to first information, whether the first indication information is valid in step S504 may further include:

Step S504-14: In a case that all HARQ-ACK feedback bits carried in a PUCCH on which a HARQ-ACK feedback of the first DCI or a HARQ-ACK feedback of the PDSCH scheduled by the first DCI is located are ACKs, determine that the first indication information is valid at an (m+K)^{th} time unit or an (n+K)^{th} time unit or after a fourth validation delay of the first indication information.

Reception of the PDSCH scheduled by the first DCI is completed at an m^{th} time unit, or reception of a PDCCH of the first DCI is completed at an n^{th} time unit, where K is an integer greater than or equal to 0.

It should be noted that a value of K in step S504-14 may be determined by using at least one of the following:
(1) K3, where a value of K3 is a time interval between a completion position of a time unit in which the PDSCH for the first DCI is received and a start position of a time unit in which a PUCCH for feeding back the HARQ-ACK feedback of the PDSCH is located, or a value of K3 is a time interval between the first DCI and feeding back the HARQ-ACK feedback of the first DCI; or
(2) an SCS configuration of the PUCCH carrying the HARQ-ACK feedback of the PDSCH or the HARQ-ACK feedback of the first DCI.

In addition, the fourth validation delay in step S504-14 in this embodiment of this application may be a time interval between completing reception of the PDSCH scheduled by the first DCI and a validation moment of the first indication information; or a time interval between completing reception of the PDCCH of the first DCI and a validation moment of the first indication information; or a time interval between the HARQ-ACK feedback of the PDSCH scheduled by the first DCI and a validation moment of the first indication information; or a time interval between the HARQ-ACK feedback of the first DCI and a validation moment of the first indication information.

According to step S504-14, it may be determined, according to a HARQ-ACK feedback result of the HARQ-ACK of the first DCI or the PDSCH scheduled by the first DCI, whether the indication information is valid and a specific validation moment is determined. Therefore, before an energy saving mode is entered (that is, before the first indication information is valid) and on the premise of ensuring data transmission reliability and performance of UE, power saving and energy saving can be achieved.

In an implementation in this embodiment of this application, the manner of determining, according to first information, whether the first indication information is valid in step S504 may further include:

Step S504-15: In a case that the first DCI schedules the PUSCH and a first condition is met, determine that the first indication information is valid.

The first condition includes one of the following: a first timer of the PUSCH expires, and reception of the DFI indicates that the PUSCH is correctly received.

According to step S504-15, it may be determined, according to whether the first timer associated with the PUSCH scheduled by the first DCI expires and whether a DFI indication sent by the network side on whether the PUSCH is correctly received by the network, whether the first indication information is valid and a specific validation moment is determined. Therefore, before an energy saving mode is entered (that is, before the first indication information is valid) and on the premise of ensuring uplink data transmission reliability and performance of UE, power saving and energy saving can be achieved.

In an implementation in this embodiment of this application, the manner of determining, according to first information, whether the first indication information is valid in step S504 may further include:

Step S504-16: In a case that a second condition is met, determining that the first indication information is invalid.

The second condition includes at least one of the following:
(1) the value of the HARQ-ACK feedback information bit of the first DCI is a Negative Acknowledgement (NACK);
(2) the value of the HARQ-ACK feedback information bit of the PDSCH scheduled by the first DCI is a NACK;
(3) the PDSCH scheduled by the first DCI is incorrectly decoded;
(4) the retransmission timer associated with the PDSCH or the PUSCH scheduled by the first DCI is started or restarted;
(5) at least one of all HARQ-ACK feedback bits carried on a PUCCH on which a HARQ-ACK feedback of the first DCI is located is a NACK;
(6) at least one of all HARQ-ACK feedback bits carried on a PUCCH on which a HARQ-ACK feedback of the PDSCH scheduled by the first DCI is located is a NACK;
(7) the first DCI schedules the PUSCH and a PDCCH for scheduling retransmission of the PUSCH is received during running of a first timer of the PUSCH; or
(8) the first DCI schedules the PUSCH and reception of the DFI indicating that the PUSCH is incorrectly received.

According to step S504-16, in a case that the second condition is met, it is determined that the first indication information dis invalid, to delay entering an energy saving mode, thereby ensuring that a subsequent energy saving related operation is performed after data transmission or a HARQ-ACK feedback is completed.

In an implementation in this embodiment of this application, the manner of determining, according to first information, whether the first indication information is valid in step S504 may further include:

Step S504-17: In a case that a third condition is met, determine, through configuration of a network side or stipulation of a protocol, that the first indication information is valid or invalid.

The third condition includes at least one of the following: a HARQ-ACK feedback of the first DCI fails to be sent; a HARQ-ACK feedback of the PDSCH scheduled by the first DCI fails to be sent; or the DFI of the PUSCH scheduled by the first DCI fails to be received.

It can be learned that whether the first indication information is valid when the third condition is met may be configured by the network side or stipulated in the protocol.

In an implementation of this embodiment of this application, the steps of the method in this embodiment of this application may further include:

Step S208: Perform a first operation in a case that the first indication information is invalid.

The first operation includes at least one of the following: starting a second timer; switching to a default search space group; or switching to a default bandwidth part BWP.

It should be noted that, the manner of starting a second timer may include: starting the second timer at an M^{th} time unit after the NACK is fed back; or starting a third timer at an N^{th} time unit after the NACK is fed back, and starting the second timer after the third timer expires, where values of M and N are integers greater than or equal to 0.

In an embodiment, the second timer may be a DRX retransmission related timer, for example, drx-retransmissiontimer, and the third timer may be drx-HARQ-RTTtimer.

In addition, in one embodiment, the first operation includes switching to the default search space group. For example, in step S504-16 and/or step S504-17 (the network side or the protocol stipulates that the first indication information is invalid when the third condition is met), after the first indication information is invalid, a currently used search space group is switched to the default search space group agreed on by the network side or the protocol to perform PDCCH monitoring. The default search space group may be a search space group 0 or a search space group 1, or any one or more search space groups newly defined in a subsequent protocol. PDCCH monitoring cycles of the search space group 0 and the search space group 1 are different.

In an implementation of this embodiment of this application, the steps of the method in this embodiment of this application may further include:

Step S210: If a second DCI carrying the first indication information is not received during running of the second timer, perform the first operation after the second timer expires, where the second DCI carries the first indication information.

In the foregoing step, the second DCI may be the first DCI.

In an implementation in this embodiment of this application, at least one of the following is applied through configuration of a network side or stipulation of a protocol during running of the retransmission timer or the first timer or the second timer:
(1) A first search space group, where the first search space group is configured by the network side or stipulated in the protocol.

It should be noted that the first search space group may be a search space group 0 or a search space group 1 in an existing protocol, or may be a search space group 2 newly defined in this application. The three search space groups include a same search space or different search spaces, or PDCCH monitoring cycles of different search space groups are different. For example, if RRC is configured to apply the search space group 1 during running of timers such as a retransmission timer, the terminal performs PDCCH monitoring on the search space group 1, where a monitoring cycle of the search space 1 is more dense or sparse.
(2) A first BWP, where the first BWP may be a large bandwidth BWP or a small bandwidth BWP.
(3) Co-slot scheduling or cross-slot scheduling.

For example, that the first DCI is associated with first indication information in this embodiment of this application includes at least one of the following: the first DCI carries the first indication information, or the first indication information is implicitly triggered by receiving the first DCI.

It should be noted that, the first indication information in this embodiment of this application is used to indicate at least one of the following: skipping PDCCH monitoring, search space group switching, BWP switching, or a minimum scheduling time interval, where the scheduling time interval is a time interval between reception of a PDSCH and reception of a PDSCH or a PUSCH scheduled by the PDCCH.

For example, the first DCI in this embodiment of this application may include the validation delay of the first indication information.

The following describes this application by using specific implementations of this embodiment of this application as an example.

### Implementation 1

In this implementation, the first DCI schedules the PDSCH and carries the PDCCH skipping indication, the scheduled PDSCH is successfully received, and the PDCCH skipping indication starts to be valid at an (n+k^{th}) slot, where

$$\text{k=k1+3} ⋅ {\text{N}}_{\text{slot}}^{\text{subframe} , μ} .$$

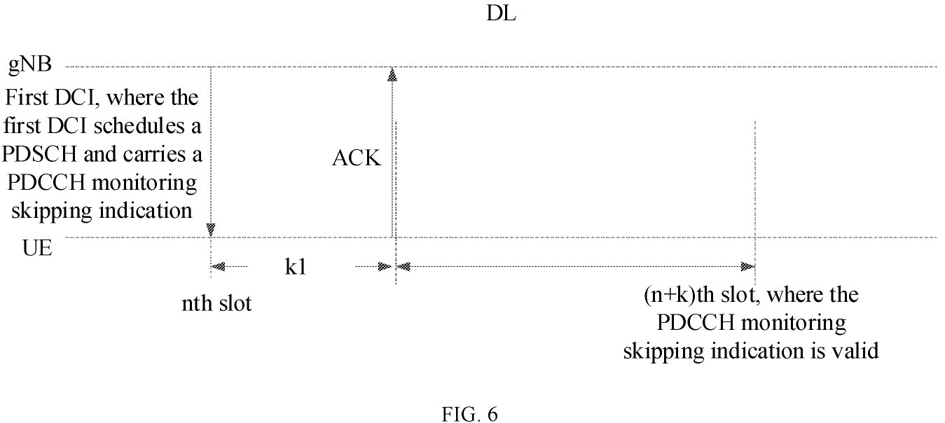

As shown in FIG. 6, reception of the PDCCH scheduled by the first DCI is completed at an n^{th} slot.

### Implementation 2:

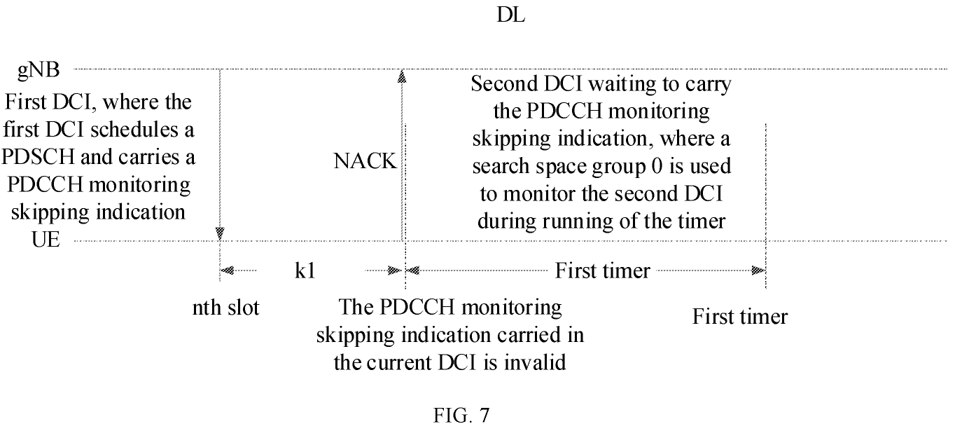

If the first DCI schedules the PDSCH and carries the PDCCH skipping indication, and the scheduled PDSCH is not successfully received, the terminal determines that the PDCCH skipping indication carried in the DCI is invalid after a NACK is confirmed, as shown in FIG. 7. After the NACK feedback is completed, the first timer is started (if DRX is configured, a DRX retransmission timer is used), and the search space group 0 is used to monitor the second DCI during running of the first timer. If the second DCI carrying the PDCCH skipping indication is still not monitored during running of the timer, the first operation is performed after the timer ends: Returning to the default search space group, and preforming PDCCH monitoring on the default BWP.

### Implementation 3:

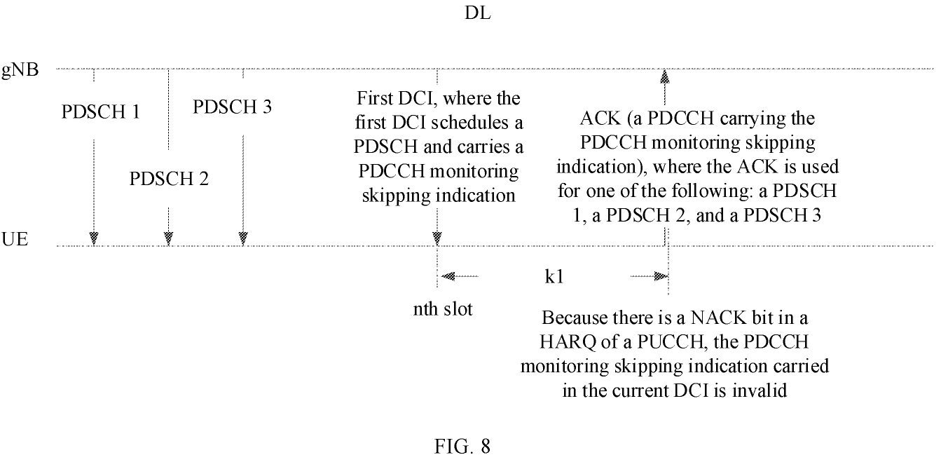

The first DCI schedules the PDSCH and carries the PDCCH skipping indication, the scheduled PDSCH is successfully received, and the HARQ feedback bit is an ACK. However, in the HARQ of the PUCCH that carries the ACK feedback bit, there is a HARQ-ACK feedback of another PDSCH, and one is a NACK. In this case, the PDCCH skipping indication carried in the first DCI is invalid, as shown in FIG. 8.

### Implementation 4:

If the first DCI schedules the PDSCH and carries the PDCCH skipping indication, the scheduled PDSCH is successfully received, the HARQ feedback bit is an ACK, and there is a HARQ feedback of another PDSCH in the HARQ of the PUCCH that carries the ACK feedback, and all are ACKs, the PDCCH skipping indication carried in the first DCI is valid in this case.

### Implementation 5:

When the first DCI does not schedule data and carries the PDCCH skipping indication, similar to the foregoing implementation 1, a difference lies in that the ACK bit of the first DCI is fed back instead of the ACK bit of the scheduled data. For a validation time, the PDCCH skipping indication starts to valid at an (n+k)^{th} slot, where

$$\text{k=k1+3} ⋅ {\text{N}}_{\text{slot}}^{\text{subframe} , μ} .$$

The first DCI is received at an n^{th} slot.

### Implementation 6:

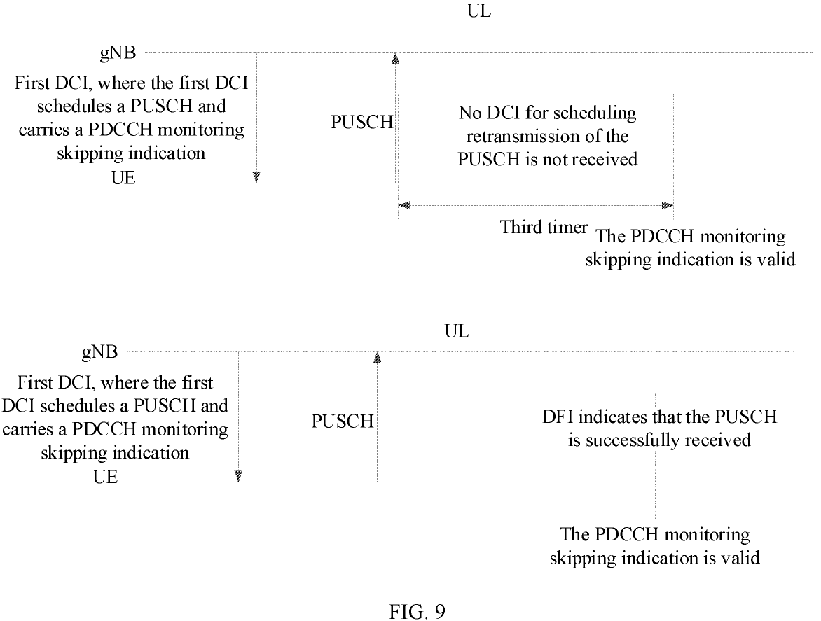

The first DCI schedules the PUSCH and carries the PDCCH skipping indication. After the third timer (when DRX is configured, drx-RetransmissionTimerUL may be used) expires or the DFI indication is correctly received, the first indication associated with the first DCI starts to be valid, as shown in FIG. 9.

### Implementation 7:

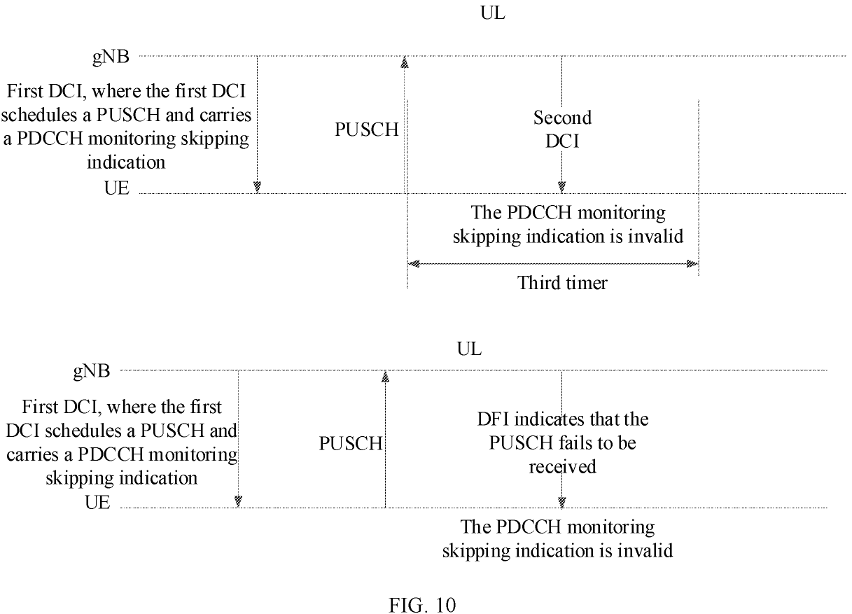

The first DCI schedules the PUSCH. If a retransmitted PDCCH for scheduling the PUSCH is received during running of the third timer or the DFI indication is incorrectly received after the terminal completes sending of the PUSCH, the first indication associated with the first DCI is invalid, and the first operation is performed. The first operation may be: returning to the default search space group, performing PDCCH monitoring on the default BWP, and the like, as shown in FIG. 10.

According to the foregoing implementations 1 to 7, in this embodiment of this application, it is determined, according to the HARQ feedback of the first DCI that carries PDCCH skipping or search space group switching or whether the PDSCH/PUSCH that is simultaneously scheduled by the first DCI is successfully received, whether the first indication associated with the first DCI is valid and a specific validation moment is determined, to ensure data transmission reliability and performance of UE, thereby implementing energy saving of the terminal. In addition, if the feedback is a NACK, a monitoring configuration of receiving the retransmitted PDCCH and a backoff operation are configured.

It should be noted that the indication information validation method provided in this embodiment of this application may be performed by an indication information validation apparatus, or a control module that is in the indication information validation apparatus and that is configured to perform the indication information validation method. In this embodiment of this application, that the indication information validation apparatus performs the indication information validation method is used as an example to describe the indication information validation apparatus provided in this embodiment of this application.

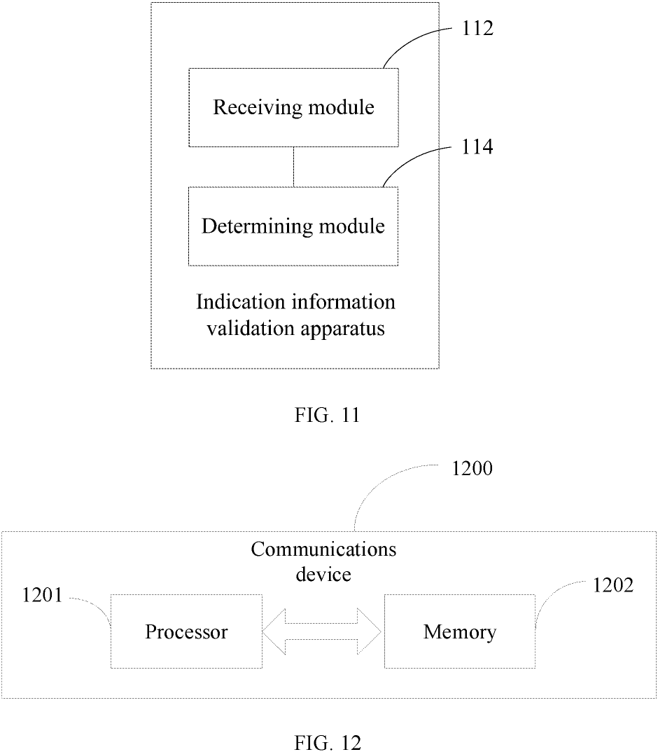

An embodiment of this application provides an indication information validation apparatus. FIG. 11 is a schematic structural diagram of an indication information validation apparatus according to an embodiment of this application. As shown in FIG. 11, the apparatus includes:
a receiving module 112, configured to receive a first downlink control indication DCI, where the first DCI is associated with first indication information, and the first indication information is an indication related to energy saving; and
a determining module 114, configured to determine, according to first information, whether the first indication information is valid, where
the first information includes at least one of the following:
   a value of a HARQ-ACK feedback information bit of the first DCI;
   a value of a feedback information bit of a physical downlink shared channel PDSCH scheduled by the first DCI;
   a HARQ-ACK downlink feedback indication DFI of a physical uplink shared channel PUSCH scheduled by the first DCI;
   whether the PDSCH or the PUSCH scheduled by the first DCI is correctly decoded;
   whether a retransmission timer associated with the PDSCH or the PUSCH scheduled by the first DCI is started or restarted;
   whether a first timer expires, where the first timer is started or restarted after sending of the PUSCH scheduled by the first DCI is completed; or
   a validation delay of the first indication information.

According to this embodiment of this application, it may indicate, according to a value of a HARQ-ACK feedback information bit of a first DCI, a value of a HARQ-ACK feedback information bit of a physical downlink shared channel PDSCH scheduled by the first DCI, a downlink feedback indication DFI of a physical uplink shared channel PUSCH scheduled by the first DCI, whether the PDSCH or the PUSCH scheduled by the first DCI is correctly decoded, whether a retransmission timer associated with the PDSCH or the PUSCH scheduled by the first DCI is started or restarted, whether a first timer expires, or a validation delay of first indication information, whether the first indication information is valid. In this way, it can be determined whether a valid mode is valid before an energy saving mode.

For example, the determining module 114 in this embodiment of this application may further include: a first determining unit, configured to: in a case that the first DCI is a DCI for non-scheduled data, and the value of the HARQ-ACK feedback information bit of the first DCI is an ACK, determine that the first indication information is valid.

The first determining unit may further include: a first determining subunit, configured to determine that the first indication information is valid after a HARQ-ACK feedback of the first DCI is completed; or a second determining subunit, configured to determine that the first indication information is valid after a first validation delay of the first indication information; or a third determining subunit, configured to determine that the first indication information is valid at an (n+K)^{th} time unit, where reception of a physical downlink control channel PDCCH of the first DCI is completed at an n^{th} time unit, where K is an integer greater than or equal to 0.

In this embodiment of this application, a value of K may be determined by using at least one of the following: K1, where a value of K1 is a time interval between a completion position of a time unit in which the PDCCH for the first DCI is received and a start position of a time unit in which a physical uplink control channel PUCCH for feeding back the HARQ-ACK feedback of the first DCI is located; or a subcarrier spacing SCS configuration of the PUCCH carrying the HARQ-ACK feedback of the first DCI.

For example, the first validation delay in this embodiment of this application includes: a time interval between completing reception of the PDCCH on which the first DCI is located and a validation moment of the first indication information; or a time interval between the HARQ-ACK feedback of the first DCI and a validation moment of the first indication information.

For example, the determining module 114 in this embodiment of this application may further include: a second determining unit, configured to: in a case that the first DCI is a DCI for scheduled data, and the value of the HARQ-ACK feedback information bit of the PDSCH scheduled by the first DCI is an ACK, determine that the first indication information is valid.

The second determining unit may further include: a fourth determining subunit, configured to determine that the first indication information is valid after a HARQ-ACK feedback of the PDSCH scheduled by the first DCI is completed; or a fifth determining subunit, configured to determine that the first indication information is valid after a second validation delay of the first indication information; or a sixth determining subunit, configured to determine that the first indication information is valid at an (n+K)^{th} time unit, where reception of the PDSCH scheduled by the first DCI is completed at an n^{th} time unit, where K is an integer greater than or equal to 0.

In this embodiment of this application, a value of K in the sixth determining subunit may be determined by using at least one of the following:
(1) K2, where a value of K2 is a time interval between a completion position of a time unit in which the PDSCH for the first DCI is received and a start position of a time unit in which a PUCCH for feeding back the HARQ-ACK feedback of the PDSCH is located; or
(2) an SCS configuration of the PUCCH carrying the HARQ-ACK of the PDSCH.

In this embodiment of this application, the second validation delay may include: a time interval between completing reception of the PDSCH scheduled by the first DCI and a validation moment of the first indication information; or a time interval between the HARQ-ACK feedback of the PDSCH scheduled by the first DCI and a validation moment of the first indication information.

For example, the determining module 114 in this embodiment of this application may further include: a third determining unit, configured to: in a case that the first DCI is a DCI for scheduled data, and the PDSCH scheduled by the first DCI is correctly decoded, determine that the first indication information is valid.

The third determining unit may further include: a seventh determining subunit, configured to determine that the first indication information is valid after the PDSCH scheduled by the first DCI is correctly decoded; or an eighth determining subunit, configured to determine that the first indication information is valid after a third validation delay of the first indication information.

For example, the third validation delay in this embodiment of this application may include: a time interval between implementing correct decoding of the PDSCH scheduled by the first DCI and a validation moment of the first indication information; or a time interval between the HARQ-ACK feedback of the PDSCH scheduled by the first DCI and a validation moment of the first indication information.

For example, the determining module 114 in this embodiment of this application may further include: a fourth determining unit, configured to: in a case that all HARQ-ACK feedback bits carried in a PUCCH on which a HARQ-ACK feedback of the first DCI or a HARQ-ACK feedback of the PDSCH scheduled by the first DCI is located are ACKs, determine that the first indication information is valid at an (m+K)^{th} time unit or an (n+K)^{th} time unit or after a fourth validation delay of the first indication information, where reception of the PDSCH scheduled by the first DCI is completed at an m^{th} time unit, or reception of a PDCCH of the first DCI is completed at an n^{th} time unit, where K is an integer greater than or equal to 0.

In this embodiment of this application, a value of K in the fourth determining unit may be determined by using at least one of the following:
(1) K3, where a value of K3 is a time interval between a completion position of a time unit in which the PDSCH for the first DCI is received and a start position of a time unit in which a PUCCH for feeding back the HARQ-ACK feedback of the PDSCH is located, and K3 may also be referred to as K1, or a value of K3 is a time interval between the first DCI and feeding back the HARQ-ACK feedback of the first DCI, and K3 may also be referred to as K2; or
(2) an SCS configuration of the PUCCH carrying the HARQ-ACK feedback of the PDSCH or the HARQ-ACK feedback of the first DCI.

In this embodiment of this application, the fourth validation delay may include: a time interval between completing reception of the PDSCH scheduled by the first DCI and a validation moment of the first indication information; or a time interval between completing reception of the PDCCH of the first DCI and a validation moment of the first indication information; or a time interval between the HARQ-ACK feedback of the PDSCH scheduled by the first DCI and a validation moment of the first indication information; or a time interval between the HARQ-ACK feedback of the first DCI and a validation moment of the first indication information.

For example, the determining module 114 in this embodiment of this application may further include: a fifth determining unit, configured to: in a case that the first DCI schedules the PUSCH and a first condition is met, determining that the first indication information is valid, where the first condition includes one of the following: a first timer of the PUSCH expires, or reception of the DFI indicates that the PUSCH is correctly received.

For example, the determining module 114 in this embodiment of this application may further include: a sixth determining unit, configured to: in a case that a second condition is met, determine that the first indication information is invalid, where
the second condition includes at least one of the following:
   (1) the value of the HARQ-ACK feedback information bit of the first DCI is an NACK;
   (2) the value of the HARQ-ACK feedback information bit of the PDSCH scheduled by the first DCI is a NACK;
   (3) the PDSCH scheduled by the first DCI is incorrectly decoded;
   (4) the retransmission timer associated with the PDSCH scheduled by the first DCI is started or restarted;
   (5) at least one of all HARQ-ACK feedback bits carried on a PUCCH on which a HARQ-ACK feedback of the first DCI is located is a NACK;
   (6) at least one of all HARQ-ACK feedbacks carried on a PUCCH on which a HARQ-ACK feedback of the PDSCH scheduled by the first DCI is located is a NACK;
   (7) the first DCI schedules the PUSCH and a PDCCH for scheduling retransmission of the PUSCH is received during running of a first timer of the PUSCH; or
   (8) the first DCI schedules the PUSCH and reception of the DFI indicating that the PUSCH is incorrectly received.

For example, the determining module 114 in this embodiment of this application may further include: a seventh determining unit, configured to: in a case that a third condition is met, determine, through configuration of a network side or stipulation of a protocol, that the first indication information is valid or invalid, where
the third condition includes at least one of the following:
   (1) a HARQ-ACK feedback of the first DCI fails to be sent;
   (2) a HARQ-ACK feedback of the PDSCH scheduled by the first DCI fails to be sent; or
   (3) the DFI of the PUSCH scheduled by the first DCI fails to be received.

For example, the apparatus in this embodiment of this application may further include a first execution module, configured to perform a first operation in a case that the first indication information is invalid, where the first operation includes at least one of the following: starting a second timer; switching to a default search space group; or switching to a default bandwidth part BWP.

For example, the starting a second timer in this embodiment of this application may include: starting the second timer at an M^{th} time unit after the NACK is fed back; or starting a third timer at an N^{th} time unit after the NACK is fed back, and starting the second timer after the third timer expires, where values of M and N are integers greater than or equal to 0.

For example, the apparatus in this embodiment of this application may further include a second execution module, configured to: if a second DCI is not received during running of the second timer, perform the first operation after the second timer expires, where the second DCI carries the first indication information.

For example, in this embodiment of this application, at least one of the following is applied through configuration of a network side or stipulation of a protocol during running of the retransmission timer or the first timer or the second timer:
(1) a first search space group, where the first search space group is configured by the network side or stipulated in the protocol;
(2) a first BWP; or
(3) co-slot scheduling or cross-slot scheduling.

For example, that the first DCI is associated with first indication information in this embodiment of this application includes at least one of the following: the first DCI carries the first indication information, or the first indication information is implicitly triggered by receiving the first DCI.

For example, the first indication information in this embodiment of this application is used to indicate at least one of the following: PDCCH monitoring skipping, search space group switching, BWP switching, or a minimum scheduling time interval, where the scheduling time interval is a time interval between reception of a PDSCH and reception of a PDSCH or a PUSCH scheduled by the PDCCH.

For example, the first DCI in this embodiment of this application includes the validation delay of the first indication information.

In addition, the first DCI in this embodiment of this application includes the validation delay of the first indication information.

The indication information validation apparatus in this embodiment of this application may be an apparatus, or may be a component, an integrated circuit, or a chip in a terminal. The apparatus may be a mobile terminal, or a non-mobile terminal. For example, the mobile terminal may include but is not limited to the types of the foregoing listed terminal 11, and the non-mobile terminal may be a server, a Network Attached Storage (NAS), a Personal Computer (PC), a Television (TV), an automated teller machine, or a self-service machine. This is not specifically limited in the embodiments of this application.

The indication information validation apparatus in this embodiment of this application may be an apparatus with an operating system. The operating system may be an Android operating system, an iOS operating system, or another possible operating system. This is not specifically limited in the embodiments of this application.

The indication information validation apparatus provided in this embodiment of this application can implement the processes implemented in the method embodiment in FIG. 5, and achieve a same technical effect. To avoid repetition, details are not described herein again.

For example, as shown in FIG. 12, an embodiment of this application further provides a communications device 1200, including a processor 1201, a memory 1202, and a program or an instruction that is stored in the memory 1202 and that can be run on the processor 1201. For example, when the communications device 1200 is a terminal, the program or the instruction is executed by the processor 1201 to implement the processes of the foregoing indication information validation method embodiment, and a same technical effect can be achieved. When the communications device 1200 is a network side device, the program or the instruction is executed by the processor 1201 to implement the processes of the foregoing indication information validation method embodiment, and a same technical effect can be achieved. To avoid repetition, details are not described herein again.

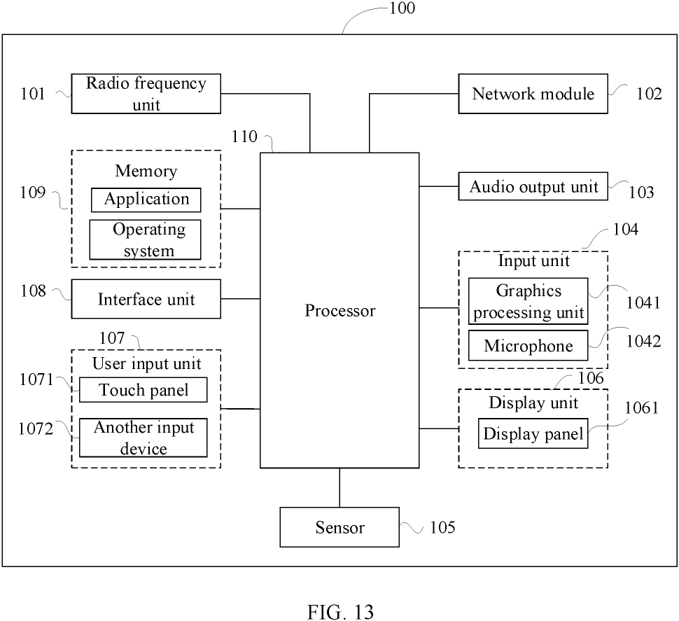

FIG. 13 is a schematic structural diagram of hardware of a terminal according to an embodiment of this application.

A terminal 100 includes but is not limited to components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the terminal 100 may further include a power supply (such as a battery) that supplies power to each component. The power supply may be logically connected to the processor 110 by using a power supply management system, to implement functions such as charging and discharging management, and power consumption management by using the power supply management system. The terminal structure shown in FIG. 13 constitutes no limitation on the terminal, and the terminal may include more or fewer components than those shown in FIG. 13, or combine some components, or have different component arrangements. Details are not described herein.

It should be understood that, in this embodiment of this application, the input unit 104 may include a Graphics Processing Unit (GPU) 1041 and a microphone 1042, and the graphics processing unit 1041 processes image data of a still picture or a video obtained by an image capture apparatus (such as a camera) in a video capture mode or an image capture mode. The display unit 106 may include a display panel 1061. For example, the display panel 1061 may be configured in a form such as a liquid crystal display or an organic light-emitting diode. The user input unit 107 includes a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, the radio frequency unit 101 receives downlink data from a network side device and then sends the downlink data to the processor 110 for processing; and sends uplink data to the network side device. Usually, the radio frequency unit 101 includes but is not limited to an antenna, at least one amplifier, a transceiver, a coupler, a low noise amplifier, a duplexer, and the like.

The memory 109 may be configured to store a software program or an instruction and various data. The memory 109 may mainly include a program or instruction storage area and a data storage area. The program or instruction storage area may store an operating system, and an application or an instruction required by at least one function (for example, a sound playing function or an image playing function). In addition, the memory 109 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage component, a flash memory component, or another non-volatile solid-state storage component.

The processor 110 may include one or more processing units. For example, an application processor and a modem processor may be integrated into the processor 110. The application processor mainly processes an operating system, a user interface, an application, an instruction, or the like. The modem processor mainly processes wireless communications, for example, a baseband processor. It can be understood that, in some alternative embodiments, the modem processor may not be integrated into the processor 110.

The radio frequency unit 101 is configured to receive a first downlink control indication DCI, where the first DCI is associated with first indication information; and
the processor 110 is configured to determine, according to first information, whether the first indication information is valid, where
the first information includes at least one of the following:
   a value of a HARQ-ACK feedback information bit of the first DCI;
   a value of a HARQ-ACK feedback information bit of a physical downlink shared channel PDSCH scheduled by the first DCI;
   a downlink feedback indication DFI of a physical uplink shared channel PUSCH scheduled by the first DCI;
   whether the PDSCH or the PUSCH scheduled by the first DCI is correctly decoded;
   whether a retransmission timer associated with the PDSCH or the PUSCH scheduled by the first DCI is started or restarted;
   whether a third timer expires; or
   a validation delay of the first indication information.

According to this application, it may indicate, according to a value of a HARQ-ACK feedback information bit of a first DCI, a value of a HARQ-ACK feedback information bit of a physical downlink shared channel PDSCH scheduled by the first DCI, a downlink feedback indication DFI of a physical uplink shared channel PUSCH scheduled by the first DCI, whether the PDSCH or the PUSCH scheduled by the first DCI is correctly decoded, whether a retransmission timer associated with the PDSCH or the PUSCH scheduled by the first DCI is started or restarted, whether a third timer expires, or a validation delay of first indication information, whether the first indication information is valid. In this way, it can be determined whether a valid mode is valid before an energy saving mode, to ensure data transmission reliability and performance of UE, thereby resolving a problem in the prior art that an accurate timing of entering the energy saving mode cannot be guaranteed by determining a manner of entering the energy saving mode according to received signaling, and ensuring accuracy of entering the energy saving mode.

An embodiment of this application further provides a readable storage medium. The readable storage medium stores a program or an instruction, and when the program or the instruction is executed by a processor, the processes of the foregoing indication information validation method embodiment are implemented and a same technical effect can be achieved. To avoid repetition, details are not described herein again.

The processor is a processor in the terminal in the foregoing embodiment. The readable storage medium includes a computer-readable storage medium, such as a computer ROM, a Random Access Memory (RAM), a magnetic disk, or an optical disc.

An embodiment of this application further provides a chip. The chip includes a processor and a communications interface, the communications interface is coupled to the processor, and the processor is configured to run a program or an instruction of a network side device to implement the processes of the foregoing indication information validation method embodiment and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a ...” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

A person of ordinary skill in the art may be aware that, in combination with the examples described in the embodiments disclosed in this specification, units and algorithm steps may be implemented by using electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of the present disclosure.

It can be clearly understood by a person skilled in the art that, for the purpose of convenient and brief description, for a detailed operating process of the foregoing system, apparatus, and unit, refer to a corresponding process in the foregoing method embodiments. Details are not described herein again.

In the embodiments provided in this application, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions in the embodiments.

In addition, functional units in the embodiments of the present disclosure may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions of the present disclosure essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a ROM, a RAM, a magnetic disk, or an optical disc.

A person of ordinary skill in the art may understand that all or some of the processes of the methods in the embodiments may be implemented by a computer program controlling related hardware. The program may be stored in a computer readable storage medium. When the program runs, the processes of the methods in the embodiments are performed. The foregoing storage medium may include: a magnetic disk, an optical disc, an ROM, or an RAM.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. An indication information validation method, performed by a terminal, comprising:
receiving a first Downlink Control Indication (DCI), wherein the first DCI is associated with first indication information, and the first indication information is an indication related to energy saving; and
determining, according to first information, whether the first indication information is valid, wherein
the first information comprises at least one of the following:
a value of a Hybrid Automatic Repeat reQuest HARQ-ACK feedback information bit of the first DCI;
a value of a HARQ-ACK feedback information bit of a Physical Downlink Shared Channel (PDSCH) scheduled by the first DCI;
a Downlink Feedback Indication (DFI) of a Physical Uplink Shared Channel (PUSCH) scheduled by the first DCI;
whether the PDSCH or the PUSCH scheduled by the first DCI is correctly decoded;
whether a retransmission timer associated with the PDSCH or the PUSCH scheduled by the first DCI is started or restarted;
whether a first timer expires, wherein the first timer is started or restarted after sending of the PUSCH scheduled by the first DCI is completed; or
a validation delay of the first indication information.

2. The indication information validation method according to claim 1, wherein the determining, according to first information, whether the first indication information is valid comprises:
in a case that the first DCI is a DCI for non-scheduled data, and the value of the HARQ-ACK feedback information bit of the first DCI is an Acknowledgement (ACK), determining that the first indication information is valid.

3. The indication information validation method according to claim 2, wherein determining that the first indication information is valid comprises:
determining that the first indication information is valid after a HARQ-ACK feedback of the first DCI is completed; or
determining that the first indication information is valid after a first validation delay of the first indication information; or
determining that the first indication information is valid at an (n+K)^{th} time unit, wherein
reception of a Physical Downlink Control Channel (PDCCH) of the first DCI is completed at an n^{th} time unit, wherein K is an integer greater than or equal to 0.

4. The indication information validation method according to claim 3, wherein a value of K is determined by using at least one of the following:
K1, wherein a value of K1 is a time interval between a completion position of a time unit in which the PDCCH for the first DCI is received and a start position of a time unit in which a Physical Uplink Control Channel (PUCCH) for feeding back the HARQ-ACK feedback of the first DCI is located; or
a Subcarrier Spacing (SCS) configuration of the PUCCH carrying the HARQ-ACK feedback of the first DCI.

5. The indication information validation method according to claim 3, wherein the first validation delay comprises:
a time interval between completing reception of the PDCCH on which the first DCI is located and a validation moment of the first indication information; or
a time interval between the HARQ-ACK feedback of the first DCI and a validation moment of the first indication information.

6. The indication information validation method according to claim 1, wherein the determining, according to first information, whether the first indication information is valid comprises:
in a case that the first DCI is a DCI for scheduled data, and the value of the HARQ-ACK feedback information bit of the PDSCH scheduled by the first DCI is an ACK, determining that the first indication information is valid.

7. The indication information validation method according to claim 6, wherein determining that the first indication information is valid comprises:
determining that the first indication information is valid after a HARQ-ACK feedback of the PDSCH is completed; or
determining that the first indication information is valid after a second validation delay of the first indication information; or
determining that the first indication information is valid at an (n+K)^{th} time unit, wherein
reception of the PDSCH scheduled by the first DCI is completed at an n^{th} time unit, wherein K is an integer greater than or equal to 0.

8. The indication information validation method according to claim 7, wherein a value of K is determined by using at least one of the following:
K2, wherein a value of K2 is a time interval between a completion position of a time unit in which the PDSCH for the first DCI is received and a start position of a time unit in which a Physical Uplink Control Channel (PUCCH) for feeding back the HARQ-ACK feedback of the PDSCH is located; or
a Subcarrier Spacing (SCS) configuration of the PUCCH carrying the HARQ-ACK feedback of the PDSCH.

9. The indication information validation method according to claim 7, wherein the second validation delay comprises:
a time interval between completing reception of the PDSCH scheduled by the first DCI and a validation moment of the first indication information; or
a time interval between the HARQ-ACK feedback of the PDSCH scheduled by the first DCI and a validation moment of the first indication information.

10. The indication information validation method according to claim 1, wherein the determining, according to first information, whether the first indication information is valid comprises:
in a case that the first DCI is a DCI for scheduled data, and the PDSCH scheduled by the first DCI is correctly decoded, determining that the first indication information is valid.

11. The indication information validation method according to claim 10, wherein determining that the first indication information is valid comprises:
determining that the first indication information is valid after the PDSCH scheduled by the first DCI is correctly decoded; or
determining that the first indication information is valid after a third validation delay of the first indication information.

12. The indication information validation method according to claim 11, wherein the third validation delay comprises:
a time interval between implementing correct decoding of the PDSCH scheduled by the first DCI and a validation moment of the first indication information; or
a time interval between the HARQ-ACK feedback of the PDSCH scheduled by the first DCI and a validation moment of the first indication information.

13. The indication information validation method according to claim 1, wherein the determining, according to first information, whether the first indication information is valid comprises:
in a case that all HARQ-ACK feedback bits carried in a Physical Uplink Control Channel (PUCCH) on which a HARQ-ACK feedback of the first DCI or a HARQ-ACK feedback of the PDSCH scheduled by the first DCI is located are ACKs, determining that the first indication information is valid at an (m+K)^{th} time unit or an (n+K)^{th} time unit or after a fourth validation delay of the first indication information, wherein
reception of the PDSCH scheduled by the first DCI is completed at an m^{th} time unit, or reception of a Physical Downlink Control Channel (PDCCH) of the first DCI is completed at an n^{th} time unit, wherein K is an integer greater than or equal to 0.

14. The indication information validation method according to claim 13, wherein a value of K is determined by using at least one of the following:
K3, wherein a value of K3 is a time interval between a completion position of a time unit in which the PDSCH for the first DCI is received and a start position of a time unit in which a PUCCH for feeding back the HARQ-ACK feedback of the PDSCH is located, or a value of K3 is a time interval between the first DCI and feeding back the HARQ-ACK feedback of the first DCI; and
a Subcarrier Spacing (SCS) configuration of the PUCCH carrying the HARQ-ACK feedback of the PDSCH or the HARQ-ACK feedback of the first DCI.

15. The indication information validation method according to claim 13, wherein the fourth validation delay comprises:
a time interval between completing reception of the PDSCH scheduled by the first DCI and a validation moment of the first indication information; or
a time interval between completing reception of the PDCCH of the first DCI and a validation moment of the first indication information; or
a time interval between the HARQ-ACK feedback of the PDSCH scheduled by the first DCI and a validation moment of the first indication information; or
a time interval between the HARQ-ACK feedback of the first DCI and a validation moment of the first indication information.

16. The indication information validation method according to claim 1, wherein the determining, according to first information, whether the first indication information is valid comprises:
in a case that the first DCI schedules the PUSCH and a first condition is met, determining that the first indication information is valid, wherein
the first condition comprises one of the following: a first timer of the PUSCH expires, and reception of the DFI indicates that the PUSCH is correctly received.

17. The indication information validation method according to claim 1, wherein the determining, according to first information, whether the first indication information is valid comprises:
in a case that a second condition is met, determining that the first indication information is invalid, wherein
the second condition comprises at least one of the following:
the value of the HARQ-ACK feedback information bit of the first DCI is a Negative Acknowledgement (NACK);
the value of the HARQ-ACK feedback information bit of the PDSCH scheduled by the first DCI is a NACK;
the PDSCH scheduled by the first DCI is incorrectly decoded;
the retransmission timer associated with the PDSCH or the PUSCH scheduled by the first DCI is started or restarted;
at least one of all HARQ-ACK feedback bits carried on a Physical Uplink Control Channel (PUCCH) on which a HARQ-ACK feedback of the first DCI is located is a NACK;
at least one of all HARQ-ACK feedback bits carried on a PUCCH on which a HARQ-ACK feedback of the PDSCH scheduled by the first DCI is located is a NACK;
the first DCI schedules the PUSCH and a Physical Downlink Control Channel (PDCCH) for scheduling retransmission of the PUSCH is received during running of a first timer of the PUSCH; or
the first DCI schedules the PUSCH and reception of the DFI indicating that the PUSCH is incorrectly received; or
in a case that a third condition is met, determining, through configuration of a network side or stipulation of a protocol, that the first indication information is valid or invalid, wherein
the third condition comprises at least one of the following:
a HARQ-ACK feedback of the first DCI fails to be sent;
a HARQ-ACK feedback of the PDSCH scheduled by the first DCI fails to be sent; or
the DFI of the PUSCH scheduled by the first DCI fails to be received.

18. The indication information validation method according to claim 1, wherein the first indication information is used to indicate at least one of the following:
Physical Downlink Control Channel (PDCCH) monitoring skipping, search space group switching, BWP switching, or a minimum scheduling time interval, wherein the scheduling time interval is a time interval between reception of a PDSCH and reception of a PDSCH or a PUSCH scheduled by the PDCCH.

19. A terminal, comprising a processor; a memory having a computer program or an instruction stored thereon, wherein the computer program or the instruction, wherein executed by the processor, causes the processor to implement operations comprising:
receiving a first Downlink Control Indication (DCI), wherein the first DCI is associated with first indication information, and the first indication information is an indication related to energy saving; and
determining, according to first information, whether the first indication information is valid, wherein
the first information comprises at least one of the following:
a value of a Hybrid Automatic Repeat reQuest HARQ-ACK feedback information bit of the first DCI;
a value of a HARQ-ACK feedback information bit of a Physical Downlink Shared Channel (PDSCH) scheduled by the first DCI;
a Downlink Feedback Indication (DFI) of a Physical Uplink Shared Channel (PUSCH) scheduled by the first DCI;
whether the PDSCH or the PUSCH scheduled by the first DCI is correctly decoded;
whether a retransmission timer associated with the PDSCH or the PUSCH scheduled by the first DCI is started or restarted;
whether a first timer expires, wherein the first timer is started or restarted after sending of the PUSCH scheduled by the first DCI is completed; or
a validation delay of the first indication information.

20. A non-transitory computer readable storage medium storing a computer program or an instruction that, when executed by a processor, causes the processor to implement operations comprising:
receiving a first Downlink Control Indication (DCI), wherein the first DCI is associated with first indication information, and the first indication information is an indication related to energy saving; and
determining, according to first information, whether the first indication information is valid, wherein
the first information comprises at least one of the following:
a value of a Hybrid Automatic Repeat reQuest HARQ-ACK feedback information bit of the first DCI;
a value of a HARQ-ACK feedback information bit of a Physical Downlink Shared Channel (PDSCH) scheduled by the first DCI;
a Downlink Feedback Indication (DFI) of a Physical Uplink Shared Channel (PUSCH) scheduled by the first DCI;
whether the PDSCH or the PUSCH scheduled by the first DCI is correctly decoded;
whether a retransmission timer associated with the PDSCH or the PUSCH scheduled by the first DCI is started or restarted;
whether a first timer expires, wherein the first timer is started or restarted after sending of the PUSCH scheduled by the first DCI is completed; or
a validation delay of the first indication information.
